(19) United States
(12) Patent Application Publication
(10) Pub. No.: US 2014/0101061 A1
(43) Pub. Date: Apr. 10, 2014

(54) CORRELATING SOFTWARE LICENSES TO SOFTWARE INSTALLATIONS

(71) Applicant: INTERNATIONAL BUSINESS MACHINES CORP, Armonk, NY (US)

(72) Inventors: Michael K. Boudreau, Orange, CA (US); Jamie B. Marsnik, Annandale, MN (US); Bradley T. Moore, Dana Point, CA (US); Craig M. Trim, Sylmar, CA (US)

(73) Assignee: INTERNATIONAL BUSINESS MACHINES CORPORATION, Armonk, NY (US)

(21) Appl. No.: 13/647,718

(22) Filed: Oct. 9, 2012

(51) Int. Cl. G06Q 99/00

(52) U.S. Cl. 705/317

(57) ABSTRACT

Embodiments of the present invention provide a system, method, and program product to correlate a plurality of software licenses for a computer program to a plurality of installations of a computer program, two or more of the plurality of software licenses licensing respective sets of program components of the computer program that differ from each other, and two or more of the plurality of installations having respective sets of program components of the computer program that differ from each other. The computer determines an amount of match between each of the plurality of installations having the respective sets of program components of the computer program, and each of the plurality of software licenses licensing the respective sets of program components of the computer program, and the computer identifies the match amount having the greatest amount of match.

### FIELD OF THE INVENTION

The present invention relates generally to managing software licenses and more specifically to correlating software licenses to software installations to determine whether the software is properly licensed.

### BACKGROUND

Large enterprises depend on a variety of software programs and numerous installations of the same type of program, to conduct operations. Software license reconciliation matches the installed software programs on their respective programmable computing devices, to valid software licenses for the purpose of demonstrating compliance with licensing terms. Software license reconciliation requires significant amounts of information in order to achieve accurate and complete coverage of installed software, by available license entitlements. Information regarding the software programs available, the types of licensing model types, i.e., serial, hostname, the attributes of the license terms, e.g., parent-child relationship, bundling, the number of installations or counts that the license permits, the permitted hardware units based on processor number, operating system, and operating environment such as development, test or production environments, on which the software programs can be installed. It is difficult for large enterprises to reconcile the software program installations to their licenses to demonstrate compliance with the licenses. This process is more complex than merely comparing the number of actual installations to the permitted number of installations in the license, for multiple reasons. Each software program may have a different licensing measurement, e.g., number of concurrent or registered users of the program, number of different computing devices in which the program is installed, number of processors used to execute the program, whether the license applies to each physical computing device (serial licensing) or each user instance of the software program, such as multiple instances on a hosting computing device (hostname licensing). Also, there may be different versions of the program throughout the enterprise, and some versions may have a subset of the functions of the others. Other factors contributing to the difficulties include software licenses that offer variable scope coverage and software products that include multiple sets of code that can be installed. For example, a software license that covers a broad range of products covers significantly more product than is actually installed. In other cases, multiple, narrower scope licenses may be applied to cover a broad product installation, often resulting in unnecessary and wasteful overlap of licensing. Also, as software is uninstalled from a computing device, migrated to another device, a computing device is decommissioned, or two or more computing devices with some or all of their software are consolidated, it is difficult to track the remaining number of installations and the applicable software licenses.

Some reconciliation approaches utilize inventory scans for manual comparison to applicable licenses. A known license manager application, such as Tivoli® License Compliance Manger (Tivoli® is a registered trademark of International Business Machines Incorporated), which tracks the license allocations to different computing devices in the enterprise. Unless meticulous tracking is done or appropriate measures are implemented, reconciliation can result in over or under licensing coverage of installed software, which in the case of over-coverage, is wasteful and costly, and in the case of under-coverage, requires an additional licensing purchase. In some cases licenses are deactivated from one device to activate an installation in another device, creating a complex, dynamic environment for reconciling software license compliance.

### SUMMARY

Embodiments of the present invention provide a system, method, and program product to correlate a plurality of software licenses for a computer program to a plurality of installations of a computer program. There are two or more of the plurality of software licenses licensing respective sets of program components of the computer program that differ from each other. Similarly there are two or more of the plurality of installations having respective sets of program components of the computer program that differ from each other.

The computer determines an amount of match between each of the plurality of installations having the respective sets of program components of the computer program, and each of the plurality of software licenses licensing the respective sets of program components of the computer program, and the computer identifies the match amount having the greatest amount of match.

In other embodiments the computer may create a first vector, wherein each dimension of the first vector corresponds to a numerical count of each component of the respective sets of program components of the computer program for each of the plurality of installations. The computer creates a second vector, in which each dimension of the second vector corresponds to a numerical count of a component of the respective sets of program components of the computer program for each of the plurality of software licenses. The computer calculates a dot product of the first vector and the second vector and also calculates a magnitude of the first vector and a magnitude of the second vector. The computer calculates a quotient of the dot product of the first vector and the second vector, and the product of the magnitude of the first vector and the magnitude of the second vector; the quotient indicating an amount of match.

In other embodiments, the calculation of the quotient by the computer further includes the computer determining a count of components in the respective sets of program components of the computer program for each of the plurality of installations. The computer performs a normalizing operation on the quotient by multiplying the quotient by a logarithm of a summation of the count of components in the respective sets of program components of the computer program for each of the plurality of installations, and a value of one.

### BRIEF DESCRIPTION OF THE SEVERAL VIEWS OF THE DRAWINGS

FIG. 1 is a functional block diagram of a software license reconciliation environment in accordance with an embodiment of the present invention.

FIG. 2 is a flowchart depicting the steps of prioritizing and reconciling pairings of installed components of computer programs to licenses of computer program components in accordance with an embodiment of the present invention.

FIG. 3 is a flowchart depicting the steps of generating a dot product in accordance with an embodiment of the present invention.

FIG. 4 is a flowchart depicting the steps of determining an amount of match by computing a similarity score in accordance with an embodiment of the present invention.

FIG. 5 is an exploded view of hardware and software within a computing device in accordance with an embodiment of the present invention.

### DETAILED DESCRIPTION

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer or other programmable data processing apparatus to produce a machine, such that the instructions, which execute via the processor of the computer or other programmable data processing apparatus, create a means for implementing the functions/acts specified in the flowchart and/or block diagram block or blocks. Embodiments of the present invention will now be described in detail with reference to the accompanying drawings.

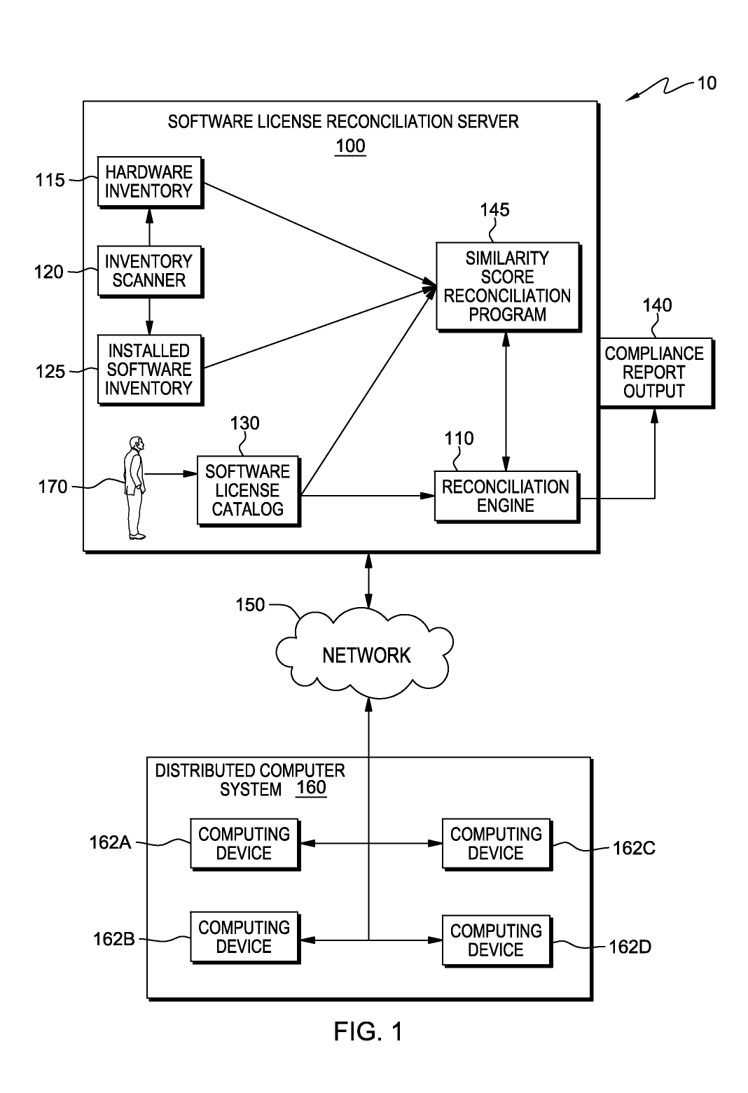

FIG. 1 is a block diagram that depicts a software license reconciliation system 10. Software license reconciliation system 10 includes a software license reconciliation server 100, a distributed computer system 160 that may be part of an enterprise or organization, and a network 150 that interconnects server 100 to distributed computer system 160. Distributed computer system 160 is represented in FIG. 1 by computing devices 162a, 162b, 162c, and 162d, for exemplary purposes, but in some embodiments can include hundreds or thousands of computing devices within an enterprise business or organization.

FIG. 1 also depicts a hardware inventory 115, an inventory scanner 120, an installed software inventory 125, a software license catalog 130, a compliance report output 140, a similarity score reconciliation program 145, and a reconciliation engine 110. A detailed description of the information used by and the operational steps performed by a (different) software license reconciliation engine, as well as further description and explanation of a rule-based software catalog and operational steps of software reconciliation, license entitlement, and constraint evaluation processes, can be found in pending patent application US 2012/0030072 A1 to Boudreau et al., entitled “CATALOG-BASED SOFTWARE LICENSE RECONCILIATION”, which is hereby incorporated by reference in its entirety, and may hereafter be referred to for examples and to establish the context of certain embodiments of the present invention.

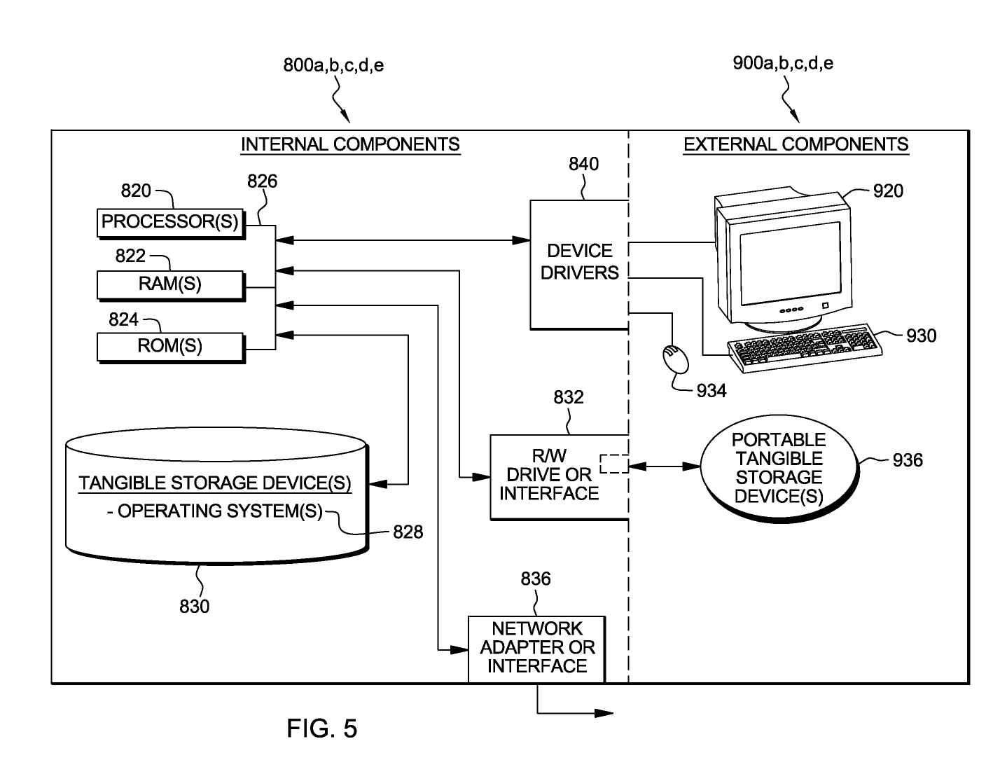

Software license reconciliation server 100 is a programmable computing device configured to perform a reconciliation of software license entitlements to installed software components, considering licensing constraints and the scope of license coverage. Software license reconciliation server 100 can be, for example, but is not limited to, a personal computer system, a desk-top computer, a server computer system, a thin client, thick client, a blade server computer, a hand-held device such as a laptop or tablet, a multiprocessor system, a microprocessor-based system, a network PC, a minicomputer system, and may be part of a network of computing devices as part of a distributed cloud computing environment that includes any of the above systems or devices. Further, software license reconciliation server 100 can be any programmable electronic device as described in more detail in FIG. 5 and capable of reconciling installed software components to license entitlements.

In one embodiment of the present invention, software license reconciliation server 100 performs the reconciliation for computing devices in distributed computer system 160, which may represent distributed computing devices that are part of an enterprise or organization. For example, computing devices 162a, 162b, 162c, and 162d, can have dozens or more installations of software components and the computing devices can be dynamically updated with new versions of existing software, new software, or removal of existing software.

Software installations of the same program installed on different computing devices of the enterprise can vary by installed components, edition, version, bundling, and can have other associated physical or environmental attributes. For example, one version of an installed software program can have one set of software components, such as software components A, B, C, F, G and H, and another version of the same program can have another set of software components, which overlaps but has more or fewer software components than the one set, such as software components A, C, D, E, F, G, H and I. The many software installations in distributed computer systems 160 may be licensed under multiple and different licenses and each of the licenses may include restrictions or constraints that affect the scope of licensing coverage. For example, some licenses license different versions of the same program, whereas others license different combinations of components for the same software program. In embodiments of the present invention, the utilization of each license is optimized by determining which software installation best matches a software license that (a) covers the edition/version of the installed software; (b) includes constraints to which the installation complies and (c) licenses those software components that most closely matches the installed software components on a computing device.

Ideally, a software license which licenses a set of software components is correlated or matched to a software installation with the same set of software components and complies with other constraints and conditions of the software license. If such a software license is not found, then typically a software license which licenses a minimum number of excess software components and which also complies with additional terms of the license, is matched to the software installation, or reconciliation reports may indicate that additional licensing entitlement needs to be obtained to be compliant.

Software license reconciliation server 100 includes hardware inventory 115, which in one embodiment, is a database that includes information regarding the hardware of each active programmable computing device in distributed computer system 160, and includes real computing devices, as well as virtual computing devices that are associated with one or more of the real computing devices. A hosting computer which has multiple instances of a software program installed and available to multiple users is considered to support virtual computing devices. Depending on license terms, a serial licensing model, in which a license covers installation for a physical computing device, or a hostname licensing model, in which a license is required to cover each available user instance of the program on a hosting machine, may be required.

Hardware inventory 115 may include, for example, but is not limited to, the identity of each computing device, the usage of each computing device, such as whether it is in a development or staging/production environment, and/or the number of processors installed in each computing device. As explained in more detail below, this information is used to determine whether installed software program components and installation conditions are in compliance with the terms and conditions of the software license. In one embodiment, the hardware inventory information for the computing devices in distributed computer system 160 is obtained by querying the configuration of each computing device which is performed by inventory scanner program 120.

In one embodiment of the present invention, inventory scanner program 120 is configured to obtain hardware and software information for each computing device in distributed computer system 160. In other embodiments, the hardware information and the software information for each computing device in distributed computer system 160, may each be obtained by different and separate scanning programs. Inventory scanner program 120 connects to each computing device in system 160 and scans for hardware information. The scan identifies each active computing device and obtains information such as the number of processors in the computing device, for example. Inventory scanner program 120 may determine if the computing device is deployed for staging/production or development operations, based on IP address or cross-referencing a hardware look-up file, updated when computing devices are added or removed from system 160. The hardware information obtained by inventory scanner program 120 is sent and stored in hardware inventory 115.

In one embodiment, inventory scanner 120 also discovers and identifies the installed software programs and program components on each computing device, within distributed computer system 160, and sends this information to installed software inventory 125. To be considered an eligible installed software component, inventory scanner 120 “discovers” the components, also referred to as artifacts, of a software program. It does so by determining: a) the presence of specific file paths or folders and filenames; and b) determines if the program artifact or component can be executed. This prevents non-functional code from being incorrectly considered for software license reconciliation. If these two conditions are met, inventory scanner program 120 deems the software as an eligible installed software component, to be further considered for software license reconciliation. In other embodiments there may be separate or multiple scanner programs to obtain hardware inventory and installed software components of computing devices in an enterprise group, such as distributed computer system 160.

Certain software programs contain components of software code, which can be completely or partially installed. Software offerings can be bundled, in which case two or more components may be installed and be covered by the scope of a single license entitlement for the entire bundle. In one embodiment, inventory scanner program 120 determines, by querying configuration files of the computing devices in which the software is installed, which components are installed and records the results to installed software inventory 125. Installed software inventory 125, in one embodiment, includes information that associates the installation of software program components with a specific computing device in enterprise environment 160.

Software license reconciliation server 100 also includes software license catalog 130, which is a compilation of software licenses corresponding to programs available to computing devices of distributed computer system 160. Software license catalog 130 also includes information regarding program components that are covered by the scope of a license, as well as licensing constraints, which are the terms and conditions associated with each software license.

Licensing constraints can be physical, such as defining on which physical devices the software program can be installed or limiting installation to devices with a specific number of processors, for example. Constraints can define if the software program components are limited to use in certain deployments such as, for example, development purposes or staging/production purposes. Constraints further include, but are not limited to, bundling, parent-child relationship and count limits of usable installations, all of which may be included in the data input to software license catalog 130. The constraint information is used to map installed software components and their installation properties to a software program license that licenses the installed components and with matching constraints.

Software programs that include multiple components, which can function independently, but offer complimentary functionality, may be offered in a single program referred to as a bundle. Bundling constraints typically cover the multiple components with a single license rather than a license count for each component. In other cases, an offering with multiple software components that are not bundled may require more than one license entitlement to cover all software components of the program.

When multiple software components are covered by a single license, one of the components of the offering is considered to be a “base product”, and the base product is associated with a count limit of the license or what is also referred to as a “used-in-count” constraint, which indicates if an installed software component is “counted” against a limited number of installations covered by the license. In such cases the other components of the software offering are not included in the “used-in-count” constraint, and the base product and other components are said to have a “parent-child” relationship constraint, in which the “child” component is dependent upon the parent (base product) for licensing coverage.

In one embodiment, the reconciliation process typically utilizes three attributes associated with licensing constraints: a used-in-counts attribute, a base product attribute, and a parent-child attribute. Each attribute of a software program is set to indicate whether the attribute is enabled or in use for a software component, or reset to indicate it is not in use or not applicable. The attributes are set or reset and included in software license catalog 130 data when the software program license is added to catalog 130.

In one embodiment, the attributes and constraints of the software program license are entered into software license catalog 130 by a person in a role such as a software license analyst or a contract manager 170, once the software license is obtained. Contract manager 170 may input attribute settings, such as “base product”, used-in-counts, and known parent-child relationships into software license catalog 130. For example, contract manager 170 may set the “base product” attribute to “1” for “yes” for one component of a multi-component bundled program, and the other components may be reset to “0” for “not” to ignore the other components in license counts. The settings are made appropriate to the installation conditions which are obtained by inventory scanner program 120, for each computing device in distributed computer system 160.

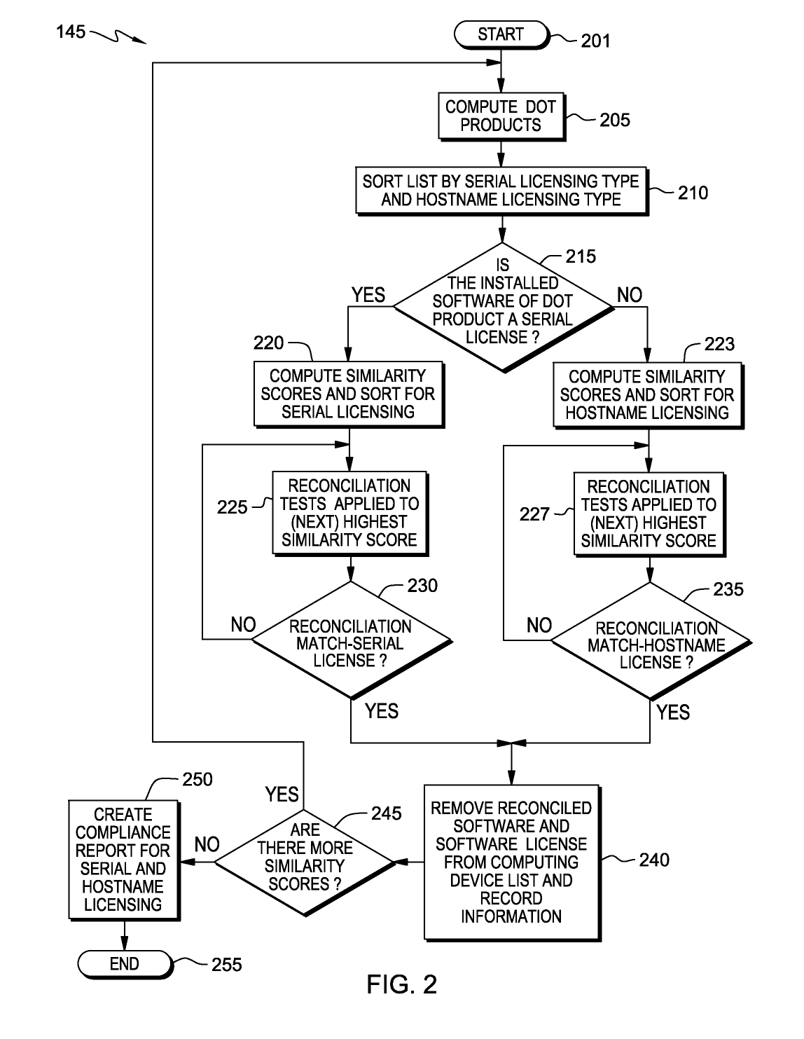

In an embodiment of the present invention, reconciliation server 100 also includes a similarity score reconciliation program 145, which receives hardware information regarding the computing devices in enterprise environment 160 from hardware inventory 115, and the installed software components associated with each computing device from installed software inventory 125. Similarity score reconciliation program 145 receives the software component information of each license from software license catalog 130. Similarity score reconciliation program 145 uses this information to compute a similarity score, which, for example can be an amount of match between the components of each of the respective installations, and the components licensed by each of the respective software licenses, which can be referred to as “pairings”, for example. The amount of match between each the components of the respective installations and the components licensed by each of the respective software licenses are hereafter referred to as the similarity score for a pairing of installed software components to software license entitlements, and will be discussed in further detail with respect to FIG. 2. The similarity score is used to prioritize the pairings, and identify the pairing with the highest similarity score, indicating a greatest amount of match, is sent to reconciliation engine 110 for further testing of constraint matching.

Reconciliation server 100 also includes reconciliation engine 110, which uses the inventoried data of software licenses and licensing constraints from software license catalog 130, the installed software components and computing device data from installed software inventory 125, and hardware inventory 115, respectively, and performs additional test to confirm constraints of the license match the software installation. The constraint test result is fed back to similarity score reconciliation program 145, which stores results and continues to loop through all pairings until the compliance/non-compliance information for all software components installed on each computing device in distributed computer system 160, has been obtained. In one embodiment, the information stored by similarity score reconciliation program 145 is used to produce compliance report output 140. Compliance report output 140 includes compliance information that relates license counts to installations for each software offering on each computing device, as well as whether or not other non-numeric license constraints have been met. In an embodiment of the present invention, a prioritization is created for reconciliation engine processing, which optimizes the pairing of license scope to installed software components.

Network 150 enables connection between the computing devices within distributed computer system 160 and software license reconciliation server 100. Network 150 can be, for example, the Internet, a local area network, a wide area network, a virtual private network or any network that enables connection between distributed computer system 160 and software license reconciliation server 100.

Distributed computer system 160 represents multiple computing devices, such as computing devices 162a, 162b, 162c, and 162d, operating, for example, in an enterprise business or organization. Distributed computer system 160 can be, for example, but is not limited to, a business organization, a section of a business organization, a government organization, non-profit organization or typically any large grouping of computing devices with installed software and shared resources for the installation, tracking and management of software licensing compliance.

Computing devices 162 a, b, c and d, can be for example, but not limited to, a personal computer, a desk-top computer, a server computer, a thin client, thick client, a blade server computer, a hand-held device such as a laptop or tablet, a smart phone, a multiprocessor system, a microprocessor-based system, a network PC, a minicomputer system, or a virtual device hosted on another computing device. The information associated with the installed software on each of computing devices 162a, 162b, 162c, and 162d, is held in installed software inventory 125, and the license entitlement information stored in software license catalog 130. Both installed software and license entitlement information are used by similarity score reconciliation program 145 to compute a correlation value or a “similarity score”, from which the amount of match for the pairing of installed software components of a computing device and components referenced by a license entitlement, can be determined. The pairing with the greatest amount of match is then sent to reconciliation engine 110 along with the respective license constraint information from software license catalog 130 and constraint testing is preformed to complete software license reconciliation. The creation of installation-license pairings, the determination of the pairing with the greatest amount of match and the reconciliation check of installation properties against license constraints, is repeated for all installations on each computing device in enterprise environment 10. The resulting compliance report output 140 indicates the compliance status of computing devices within the enterprise, such as, for example, computing devices 162a, 162b, 162c, and 162d, in enterprise environment 160.

FIG. 2 is a flowchart depicting the steps of a similarity score reconciliation program 145, which determines an amount of match between each the components of the respective installations and the components licensed by each of the respective software licenses, referred to as the similarity scores of software program licenses to sets of software components installed on computing devices. Similarity score reconciliation program 145 computes correlation values or “similarity scores” used to prioritize which software license has the greatest amount of match with which installed software component(s) and results in an optimized application of license scope. In one embodiment, similarity score reconciliation program 145 produces a reconciliation report for a defined set of computing devices with installed software components and software licenses. In one embodiment, similarity score reconciliation program 145 resides on or is accessible from reconciliation server 100, and has access to existing inventories of the computing devices, the software licenses and their constraints, and the installed software components discovered by inventory scanner 120, within distributed computer system 160. The steps of similarity score reconciliation program 145 include computing a dot product of two vectors. One vector is created by using a count of a set of installed program components of a computer program, discovered on a computing device. Each discovered component is a dimension of the vector. The other vector is created from a count of set of program components referenced by a license (typically 1 for each license component).

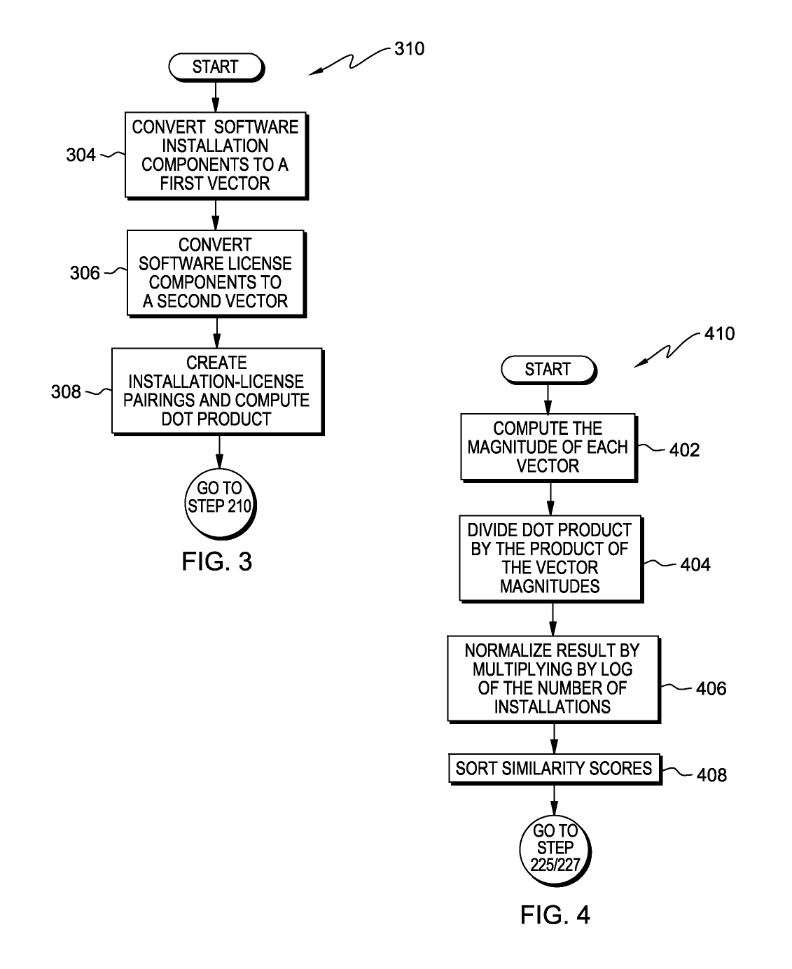

The dot product of the vectors is used to compute a similarity score which associates an amount of match value for a pairing of software components installed on a computing device and software components referenced by the license entitlement, which licenses those installed components. The description of the flowchart for similarity score reconciliation program 145 begins with FIG. 2 and references FIG. 3 to describe generating the dot product in more detail, and also references FIG. 4 to describe generating similarity scores for each dot product pairing. The description returns to FIG. 2 as appropriate to complete the process steps of similarity score reconciliation program 145.

Similarity score reconciliation program 145 is initiated, for example, by manual command or by scheduled run time (step 201), and proceeds to step 205 in which dot product function 310 is called and initiated to create pairings and compute dot products.

FIG. 3 is a flowchart depicting the steps of dot product function 310 in more detail. Dot product function 310 computes a dot product value for each pairing of installed program components of a computer program on a computing device, and program components licensed by computer program license entitlements, for each computing device in distributed computer system 160.

Dot product function 310 is initiated by similarity score reconciliation program 145 (step 205), and creates pairings of computing devices with respective sets of installed program components of a computer program, that may differ from each other, with respective sets of program components licensed by license entitlements for a computer program, that may differ from each other. Dot product function 310 converts the installed components of each computer program on each computing device to a vector (step 304), with the count of each program component corresponding to a dimension of the vector, and each vector corresponding to a computing device. Dot product function 310 converts the program components referenced by the license of the computer program to a second vector (step 306), with each component referenced by the license for the computer program corresponding to a dimension of the vector. Dot product function 310 performs a dot product computation (step 308) between each installation vector and each license entitlement vector of a computer program, for every computing device in enterprise environment 160.

The dot product serves as the numerator of the similarity score computation. A similarity score refers to a computed value indicating an amount of match or similarity between computer program components installed on a computing device and a computer software program license licensing program components for the computer program. The similarity score computation will result in a decrease in the similarity score value if additional licensed program components are not installed on a computing device or if additional program components are installed on a computing device but are not referenced in the license entitlement of the computer program. Decreasing the value of the similarity score, as will be discussed in detail later, indicates less similarity or a reduced amount of match between the installed components and licensed components. A pairing with a higher similarity score or higher amount of match is chosen over a pairing with a lower similarity score, for software license reconciliation, which supports optimal application of software license scope. If two or more computing device/license pairings have the same correlation value or similarity score, then typically the computing device with a larger number of total computer programs installed would be selected and sent to reconciliation engine 110 for constraint testing.

In an exemplary embodiment, for enterprise environment 160 there may be dozens or even hundreds of different software offering components and a variety of combinations of these components can be installed on the different computing devices. The scanning data in installed software inventory 125 is received by similarity score reconciliation program 145. Dot product function 310 is called in step 205 (FIG. 2) and uses the information from installed software inventory 125 and software license catalog 130 to create pairings of installations and licenses, for each computing device. Dot product function 310 uses the information stored in installed software inventory 125 to convert installed program component information on computing device 162a, to a first vector (step 304). The numeric count of each installed program component of a computer software program on computing device 162a corresponds, respectively, to a dimension of the vector.

Software license entitlement information for enterprise environment 160 is stored in software offering license catalog 130. Dot product function 310 uses information from software license catalog 130 and converts the program component information referenced by the license entitlement to a second vector (step 306), with the numeric count of each program component of the license entitlement corresponding to a dimension of the vector.

Dot product function 310 performs a dot product computation (step 308) by computing the product of each first vector representing a computing device with installed computer software program components, with each second vector representing program components licensed by computer software program license entitlements. If a software offering is not installed on a specific computing device, no dot product is calculated for that installed software/software license pairing or the dot product is set to zero (and likewise the similarity score will be zero). Dot product function 310 stores the dot product values for use in other operations and ends by returning control to similarity score reconciliation program 145.

Returning to similarity score reconciliation program 145, (FIG. 2, step 210) similarity scoring reconciliation program 145 sorts the computed dot product by licensing type; grouping hostname type licensing separate from serial type licensing (step 210). Similarity score reconciliation program 145 checks each dot product pairing (step 215) to determine if the license type is a serial licensing model. A serial type licensing model would assign software used by virtual computing devices to the host of the virtual devices, whereas a hostname licensing model would assign a software installation for a virtual computing device, to each virtual device. Recording software license reconciliation by license model results in accurate reconciliation, prevents license scope waste, and optimizes license scope coverage.

For the case in which the installed software components/software license pairing dot products are associated with serial license model types, (step 215, “yes” branch), similarity score reconciliation program 145 calls similarity score function 410 (step 220) to compute a similarity score for each dot product. The steps of similarity score function 410 are illustrated in the flowchart of FIG. 4. Similarity score function 410 uses the vectors and dot product values computed by dot product function 310 and computes a similarity score, such as, for example, a cosine similarity value of the two vectors used to compute the amount of match between the installed program components and the license components for each of the pairings. The similarity score is an indicator of how closely the components referenced by the license align to the software components installed on a computing device. In one embodiment, the score is normalized to obtain results between 0 and 1, and the higher the score, the more closely the license aligns with the installed software component(s).

To compute the similarity score, the magnitudes of the two vectors used to calculate each dot product, are computed (step 402) by squaring each dimension term of the vector, summing the squared terms, and taking the square root of the resulting sum, (this assumes the magnitude of each vector is calculated from an origin point with each dimension of the origin equal to zero). The product of the two vector magnitudes is used as a divisor of the dot product dividend (step 404), and results in a quotient value between 0 and 1. In a preferred embodiment, the similarity score is computed using a cosine similarity operation. In other embodiments, other correlation operations may be used to compute the closeness-of-fit, however, the result remains a similarity measurement that can be used to prioritize the selection of a pairing of a computing device with installed computer software program components and computer software offering license entitlements, for software license reconciliation.

In another embodiment, a simplified similarity matching approach can be used. For example, if software license #L1 licenses components A, B, C, D, E and F, and software installation #I6 includes components A, B, C, E and F, then the correlation score is “4” between this license and this installation based on a match of five components A, B, C, E and F, and one extra licensed component D not found in the installation, i.e., number of matches minus number of extra licensed components. If software installation #I7 includes components A, B, C and E, then the similarity value, which can be referred to in this case as a correlation score, is “2” between this license and this installation based on a match of four components A, B, C and E, and two extra licensed components D and F not found in the installation, i.e., 4−2=2. If software installation #I8 includes components A, B, C, D, E and F, then the correlation score is “6” between this license and this installation based on a match of six components A, B, C, D, E and F, and zero extra licensed components not found in the installation, i.e., 6−0=6. These correlation scores can be used to prioritize pairings of installed software components to components referenced by license entitlements. Prioritizing pairings adds significant efficiency to reconciliation testing for license constraints against the installation environment conditions of the installed computer software program.

There may be instances in which one or more computing device(s) have a very low number of installed software components, whereas other computing devices may have a very large number of installed software components. Similarity scores of computing devices with few installed software components may be skewed to a higher similarity score. In an embodiment of the present invention, this effect is accounted for by performing a normalizing operation (step 406), in which each similarity score is multiplied by the logarithm of the total number of software component installations on a given computing device, plus one, (e.g., log(total number of installed components+1)). The addition of “plus one” covers rare instances in which a computing device may have only one component installation, such as an operating system, in which case the intent is to normalize the similarity score and avoid multiplying by log(1), which would result in a similarity score of zero.

After the normalization is complete, the resulting value is the similarity score that is used to determine the highest ranking pairing of installed computer programs/computer program licenses, for software license reconciliation. The similarity scores are sorted by value from highest to lowest (step 408), with a high similarity score indicating a closer fit of installed software components to components referenced by the license entitlement.

If the licensing type of the dot products in similarity score reconciliation program 145 is hostname licensing (step 215, “no” branch), then similarity score reconciliation program 145 calls similarity score function 410 (step 223) and similarity values are computed as described above for the serial licensing model and the hostname licensing model, and the similarity values are sorted highest to lowest. Similarity score function 410 ends by returning sorted similarity scores and program control, to similarity score reconciliation program 145, which resumes at step 225 (FIG. 2) for similarity scores associated with serial type license models, and step 227 for similarity scores associated with hostname licensing models. Steps 225 and 227 perform the same processing, but are associated with installed software/software licensing pairings that apply to serial licensing models and hostname licensing models, respectively. In a preferred embodiment, software reconciliation information generated by similarity score reconciliation program 145 is computed and stored separately by serial and hostname license model. The separation of reconciliation by license model type improves optimization of license coverage and enables reporting by license model type.

For serial license model type similarity scores, the sorted similarity scores are returned to similarity score reconciliation program 145 and the installed software/software license pairing with the highest similarity score is identified and submitted to reconciliation tests (step 225) to determine if the installed software is a match to the additional constraints that may apply to the license entitlement. For example, the installed software may be one of a set of software program components that are bundled together, and one of the program components would be expected to be flagged as a “base product”. The designation of a base product is used to apply a count of the number of installations of program components and the license constraint of installation counts is referred to as “used-in-counts”. With this designation, the base product is counted against the limit of installations for the program, whereas the installed software components of the program that are not designated as a base product are not counted against the used-in-counts constraint. If the limit of installations has been exceeded, then a “non-compliant” status is included in the output report and information to achieve compliance is recorded to indicate the licensing requirements.

Other constraints are considered as well in reconciliation tests (step 225/227), for example, constraints associated with the installation environment of the computing device on which the software offering is installed, or the installation environment in which the computing device resides can also be constraints of the license. If constraint conditions are not satisfied, the installed software/software offering license pairing is not a match, and a different pairing of the installed program components may be considered to determine if the constraints and installation conditions prove to be a match. If the reconciliation tests result in a match (step 230, “yes” branch), then the installed software/software license pairing is removed or excluded from the computing device installation/license entitlement list (step 240), and the installed software/software license pairing and associated information, is recorded as compliant. If the reconciliation tests do not result in a match (step 230, “no” branch), then the pairing is set aside and the next highest ranked pairing, which has the next highest similarity score or the next greatest amount of match for the same license model type, is selected and the reconciliation tests are repeated on the selection of the pairing with the next greatest amount of match. Similarly, reconciliation tests are done on the high similarity score hostname license model type (step 227) and reconciliation matching of hostname license pairings (step 235, “yes” branch) is determined and recorded as compliant if there is a match (step 240), or the similarity score pairing is replaced without recording information if there is no match (step 235, “no” branch), and the next highest similarity score (hostname license model) is selected and receives reconciliation tests (step 227). For additional details regarding the reconciliation tests and the functions of a reconciliation engine, see pending patent application US 2012/0030072; “Catalog-Based Software License Reconciliation”, Boudreau et al.

In one embodiment, the compliance status and information associated with the installed software components/software offering license entitlement pairing, is stored, for example, on tangible storage device 830 (FIG. 5) for compliance reporting. Similarity score reconciliation program 145 then determines if there are similarity scores remaining (step 245) and following the “yes” branch, returns to recalculate the similarity scores of all pairings of installed software and software offering licenses, that are still included (step 205). Having removed (excluded) a pairing of installed software and software offering license, the vector values may change and the dot products and similarity scores are recalculated for the pairings that have not been excluded. Similarity score reconciliation program 145 continues to loop until all pairings have had reconciliation tests applied and matching/non-matching determined. If no similarity scores remain (step 245, “no” branch), then in one embodiment, similarity score reconciliation program 145 creates and outputs compliance report output 140 (step 250). In other embodiments, reconciliation program outputs may be generated by user request, by a pre-scheduling an output initiation time, or by another method. After creating the output report, similarity score reconciliation program 145 ends (step 255).

Continually re-computing dot products for remaining pairings of computing device with installed software components and software offering license entitlements, and computing similarity scores for each dot product pairing, until all installed software components have been reconciled, can create high demands on the processor(s) of reconciliation server 100. In an alternative embodiment, similarity score reconciliation program 145 can loop through and apply reconciliation tests (step 225/227) and check for constraint matching (step 230/235) for pairings within a range of similarity scores that exceed a predetermined limit, before re-computing and sorting similarity scores after only one pairing has been reconciled. This modification allows a selection of a similarity score range that can reduce the demand on the processor(s) of reconciliation server 100, but may produce a slightly less optimal reconciliation result.

In a simplified exemplary embodiment, a similarity score is determined for installed software components on computing device 162a and the software component licensing entitlements. The software programs and components used in the example are fictitious and are intended to illustrate an example of the ideas presented herein. The information regarding the installed software components and the software offering license entitlements are stored in installed software inventory 125 and software license catalog 130, respectively. Entitlement licenses of software offerings and components are summarized in Table 1. The license model for the example is assumed to be serial type licensing. Installed software programs and/or components of programs are referred to as “software components”.

TABLE 1
SOFTWARE PROGRAM LICENSES/LICENSED COMPONENTS

| | Software Program Licenses: | | | | |
|---|---|---|---|---|---|
| | | Ex- | | | |
| | Ex- | Businex | | | |
| | Businex | Pro- | | | Ex- |
| | Standard | fessional | Ex- | | Present- |
| Component | edition | edition | Write-It | Ex-Calc-It | It |
| Ex-Write-It | 1 | 1 | 1 | 0 | 0 |
| Ex-Calc-It | 1 | 1 | 0 | 1 | 0 |
| Ex-Present-It | 1 | 1 | 0 | 0 | 1 |
| Ex-Mail-It | 0 | 1 | 0 | 0 | 0 |
| Coordinates: | (1, 1, 1, 0) | (1, 1, 1, 1) | (1, 0, 0, 0) | (0, 1, 0, 0) | (0, 0, 1, 0) |

In the example, Table 1 represents the mock software offerings which include: Ex-Businex Standard edition, Ex-Businex Professional edition, Ex-Write-It, Ex-Calc-It, and Ex-Present-It. The Ex-Businex Standard edition license includes licensing entitlement for an installation of Ex-Write-It, Ex-Calc-It, Ex-Present-It, and the Ex-Businex Professional edition includes licensing entitlement for an installation of Ex-Write-It, Ex-Calc-It, Ex-Present-It and Ex-Mail-It. Additionally, there are licenses for individual installations of Ex-Write-It, Ex-Calc-It, and Ex-Present-It. Each column represents a software license entitlement vector. The installed software components for computing devices 162a, 162b, 162c, and 162d, are summarized in Table 2.

TABLE 2
SOFTWARE COMPONENTS INSTALLED
ON EACH COMPUTING DEVICE

| | Computing | Computing | Computing | Computing |
|---|---|---|---|---|
| | Device 162a | Device 162b | Device 162c | Device 162d |
| Ex-Write-It | 2 | 0 | 1 | 1 |
| Ex-Calc-It | 1 | 0 | 0 | 1 |
| Ex-Present-It | 1 | 1 | 0 | 0 |
| Ex-Mail-It | 1 | 0 | 0 | 0 |
| Coordinates: | (2, 1, 1, 1) | (0, 0, 1, 0) | (1, 0, 0, 0) | (1, 1, 0, 0) |

In the example, Table 2 depicts that computing device 162a is functioning as a host for a virtual computing device and therefore has a multiple count of Ex-Write-It installed along with one installation of Ex-Calc-It and Ex-Mail-It. The vector coordinates for computing device 162a are converted from the instances of installed software, which produces the coordinates: (2,1,1,1). The coordinates for other computing devices in enterprise environment 160 are generated similarly.

The computed dot product of installed software for computing device 162a and each offering in the example is illustrated in Table 3. The vector values used for dot product calculations are also used to determine the vector length or magnitude for each of the pairings of the installed software components on computing device 162a and the software offering license entitlements. The vector magnitudes are illustrated in Table 4. Similarity scores can be computed by dividing the dot product by the product of the vector magnitudes. Normalization, as described above, (multiplying the similarity value by the log of the number of installed software components (4)+1), is performed and produces the similarity score for the installed

TABLE 3
COMPUTED DOT PRODUCT

| | | | Dot Product |
|---|---|---|---|
| | | License | Value |
| Computing Device 162a | X | Ex-Businex | 3 |
| installed software | | Standard edition | |
| components | | | |
| Computing Device 162a | X | Ex-Businex | 5 |
| installed software | | Professional | |
| components | | edition | |
| Computing Device 162a | X | Ex-Write-It | 2 |
| installed software | | | |
| components | | | |
| Computing Device 162a | X | Ex-Calc-It | 1 |
| installed software | | | |
| components | | | |
| Computing Device 162a | X | Ex-Present-It | 0 |
| installed software | | | |
| components | | | |
| Computing Device 162a | X | Ex-Mail-It | Not a separate |
| installed software | | | offering |
| components | | | |

TABLE 4
VECTOR MAGNITUDE
Calculation of Vector Length - using
vector coordinates and (0,0,0,0) origin

| License | Length | Computing Device | Length |
|---|---|---|---|
| Ex-Businex | 1.732051 | Computing Device 162a | 2.645751311 |
| Standard edition | | | |
| Ex-Businex | 2 | Computing Device 162b | 1 |
| Professional edition | | | |
| Ex-Write-It | 1 | Computing Device 162c | 1 |
| Ex-Calc-It | 1 | Computing Device 162d | 1.414213562 |
| Ex-Present-It | 1 | | |

software (on computing device 162a) and software license pairing. Computed similarity scores for computing device 162a are presented in Table 5.

TABLE 5
SIMILARITY SCORES FOR COMPUTER
DEVICE 162A AND LICENSE PAIRINGS

| | | Dot-Product/ | | |
|---|---|---|---|---|
| | | (Vector | | |
| | | Magnitude | | Similarity |
| | License | Product) | Normalization | Score |
| Comp. Device | Ex-Businex | 0.944911 | 0.6990 | 0.6605 |
| 162a | Professional | | | |
| Comp. Device | Ex-Businex | 0.707107 | 0.6990 | 0.4943 |
| 162a | Standard | | | |
| Comp. Device | Ex-Write-It | 0.816497 | 0.6990 | 0.5284 |
| 162a | | | | |
| Comp. Device | Ex-Calc-It | 0.408248 | 0.6990 | 0.1229 |
| 162a | | | | |
| Comp. Device | Ex-Present-It | 0.377964 | 0.6990 | 0.2642 |
| 162a | | | | |

The similarity score of the installed software components for computing device 162a and the software license entitlement for Ex-Businex Prof is the highest value, and this pairing would be applied to reconciliation test in step 225 of similarity score reconciliation program 145. In the example embodiment, the additional constraints of the Ex-Businex Prof offering are found to match the installation in computing device 162a and the software offering license has a count applied to it and the installed software for computing device 162a that is covered by the license scope is removed from the dot product list and the information associated with the reconciliation is stored to be included in a final reconciliation report.

The foregoing description of various embodiments of the present invention has been presented for purposes of illustration and description. It is not intended to be exhaustive nor to limit the invention to the precise form disclosed. Many modifications and variations are possible. Such modifications and variations that may be apparent to a person skilled in the art of the invention are intended to be included within the scope of the invention as defined by the accompanying claims.

FIG. 5 shows a block diagram of the components of a data processing system 800, 900, such as user computing devices 162a, 162b, 162c, and 162d, and/or reconciliation server 100, in accordance with an illustrative embodiment of the present invention. It should be appreciated that FIG. 5 provides only an illustration of one implementation and does not imply any limitation with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User computing devices 162a, 162b, 162c, and 162d, and software license reconciliation server 100, include respective sets of internal components 800 a, b, c, d, e, and external components 900 a, b, c, d, e, illustrated in FIG. 5. Each of the sets of internal components 800 a, b, c, d, e, includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and similarity score reconciliation program 145, Dot product function 310 and similarity score function 410, in reconciliation server 100, as well as other software license reconciliation inventory information and data, are stored on one or more of the respective computer-readable tangible storage devices 830 for execution by one or more of the respective processors 820 via one or more of the respective RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, c, d, e, also includes a R/W drive or interface 832 to read from and write to one or more portable computer-readable tangible storage devices 936 such as a CD-ROM, DVD, memory stick, magnetic tape, magnetic disk, optical disk or semiconductor storage device. Similarity score reconciliation program 145, dot product function 310, and similarity score function 410, run by reconciliation server 100, as well as other software license reconciliation inventory information and data, can be stored on one or more of the respective portable computer-readable tangible storage devices 936, read via the respective R/W drive or interface 832 and loaded into the respective tangible storage device 830.

Each set of internal components 800 a, b, c, d, e, also includes network adapters or interfaces 836 such as a TCP/IP adapter cards, wireless wi-fi interface cards, or 3G or 4G wireless interface cards or other wired or wireless communication links. Similarity score reconciliation program 145, dot product function 310, and similarity score function 410, can be downloaded to reconciliation server 100 from an external computer via a network (for example, the Internet, a local area network or other, wide area network) and respective network adapters or interfaces 836. From network adapters or interfaces 836, similarity score reconciliation program 145, dot product function 310 and similarity score function 410 are loaded into the respective computer-readable tangible storage device(s) 830. The network may comprise copper wires, optical fibers, wireless transmission, routers, firewalls, switches, gateway computers and/or edge servers.

Each of the sets of external components 900 a, b, c, d, e, can include a computer display monitor 920, a keyboard 930, and a computer mouse 934. External components 900 a, b, c, d, e, can also include touch screens, virtual keyboards, touch pads, pointing devices, and other human interface devices. Each of the sets of internal components 800 a, b, c, d, e, also includes device drivers 840 to interface to computer display monitor 920, keyboard 930, and computer mouse 934. The device drivers 840, R/W drive or interface 832, and network adapter or interface 836 comprise hardware and software (stored in storage device 830 and/or ROM 824). Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

Based on the foregoing, computer system, method and program product have been disclosed in accordance with the present invention. However, numerous modifications and substitutions can be made without deviating from the scope of the present invention. Therefore, the present invention has been disclosed by way of example and not limitation.

What is claimed is:

1. A method for correlating a plurality of software licenses for a computer program to a plurality of installations of the computer program, two or more of the plurality of software licenses licensing respective sets of program components of the computer program that differ from each other, and two or more of the plurality of installations having the respective sets of program components of the computer program that differ from each other, the method comprising:
a computer determining an amount of match between the components of each of the respective installations, and the components licensed by each of the respective software licenses; and
the computer identifying one of the installations having a greatest amount of the match to one of the software licenses.

2. A method in accordance with claim 1, each of the plurality of software licenses for the computer program having one or more license constraints relating to an installation environment of the computer program,
wherein the step of the computer identifying one of the installations having the greatest amount of the match to one of the software licenses further comprises:
the computer identifying the installation and the software license associated with a match amount having a greatest amount of match, wherein the installation environment of the associated installation satisfies the one or more license constraints of the associated software license.

3. The method in accordance with claim 1, wherein the step of the computer determining the amount of match between the components of each of the respective installations, and the components licensed by each of the respective software licenses, further comprises:
the computer creating a first vector, wherein each dimension of the first vector corresponds to a numerical count of each component of the respective sets of program components of the computer program for each of the plurality of installations;
the computer creating a second vector, wherein each dimension of the second vector corresponds to a numerical count of a component of the respective sets of program components of the computer program for each of the plurality of software licenses;
the computer calculating a dot product of the first vector and the second vector;
the computer calculating a magnitude of the first vector and a magnitude of the second vector; and
the computer calculating a quotient of the dot product of the first vector and the second vector, and the product of the magnitude of the first vector and the magnitude of the second vector.

4. The method in accordance with claim 3, wherein the step of the computer calculating a quotient further comprises:
the computer determining a count of components in the respective sets of program components of the computer program for each of the plurality of installations; and
the computer performing a normalizing operation on the quotient by multiplying the quotient by a logarithm of a summation of the count of components in the respective sets of program components of the computer program for each of the plurality of installations, and a value of one.

5. The method in accordance with claim 1, further comprising the step of:
the computer separately sorting and storing the amount of match between the components of each of the respective installations, and the components licensed by each of the respective software licenses based on whether the software licenses licensing the respective sets of program components are a serial model license or a hostname model license.

6. The method in accordance with claim 1, wherein the step of the computer identifying one of the installations having the greatest amount of the match to one the software licenses, further comprises:
the computer identifying the respective installations and the respective software licenses associated with a match amount wherein the match amount exceeds a predetermined amount of match.

7. The method in accordance with claim 1, wherein the one of the software licenses has at least the components to license the components of the one of the installations.

8. A computer system for correlating a plurality of software licenses for a computer program to a plurality of installations of the computer program, two or more of the plurality of software licenses licensing respective sets of program components of the computer program that differ from each other, and two or more of the plurality of installations having the respective sets of program components of the computer program that differ from each other, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to determine an amount of match between the components of each of the respective installations, and the components licensed by each of the respective software licenses; and
program instructions to identify one of the installations having a greatest amount of the match to one of the software licenses.

9. The computer system of claim 8, wherein each of the plurality of software licenses for the computer program having one or more license constraints relating to an installation environment of the computer program,
wherein the program instructions to identify one of the installations having the greatest amount of the match to one of the software licenses, further comprises:
program instructions to identify the installation and the software license associated with a match amount having a greatest amount of match, wherein the installation environment of the associated installation satisfies the one or more license constraints of the associated software license.

10. The computer system of claim 8, wherein the step of the program instructions determining the amount of match between the components of each of the respective installations, and the components licensed by each of the respective software licenses, further comprises:
program instructions to create a first vector, wherein each dimension of the first vector corresponds to a numerical count of each component of the respective sets of program components of the computer program for each of the plurality of installations;
program instructions to create a second vector, wherein each dimension of the second vector corresponds to a numerical count of each component of the respective sets of program components of the computer program for each of the plurality of software licenses;
program instructions to calculate a dot product of the first vector and the second vector;
program instructions to calculate a magnitude of the first vector and a magnitude of the second vector; and
program instructions to calculate a quotient of the dot product of the first vector and the second vector, and the product of the magnitude of the first vector and the magnitude of the second vector.

11. The computer system of claim 10, wherein the program instructions calculating a quotient further comprises:
program instructions to determine a count of components in the respective sets of program components of the computer program for each of the plurality of installations; and
program instructions to perform a normalizing operation on the quotient by multiplying the quotient by a logarithm of a summation of the count of components in the respective sets of program components of the computer program for each of the plurality of installations, and a value of one.

12. The computer system of claim 8, further comprising:
program instructions to separately sort and store the amount of match between the components of each of the respective installations, and the components licensed by each of the respective software licenses, based on whether the software licenses licensing the respective sets of program components of the computer program are a serial model license or a hostname model license.

13. The computer system of claim 8, wherein the program instructions to identify one of the installations having the greatest amount of the match to one the software licenses further comprises:
program instructions to identify the respective installations and the respective software licenses associated with the match amount wherein the match amount exceeds a predetermined amount of match.

14. A computer program product for correlating a plurality of software licenses for a computer program to a plurality of installations of the computer program, two or more of the plurality of software licenses licensing respective sets of program components of the computer program that differ from each other, and two or more of the plurality of installations having the respective sets of program components of the computer program that differ from each other, the computer program product comprising:
one or more computer-readable storage devices and program instructions stored on at least one of the one or more tangible storage devices, the program instructions comprising:
program instructions to determine an amount of match between the components of each of the respective installations, and the components licensed by each of the respective software licenses; and
program instructions to identify one of the installations having a greatest amount of the match to one of the software licenses.

15. The computer program product of claim 14, each of the plurality of software licenses for the computer program having one or more license constraints relating to an installation environment of the computer program,
wherein the program instructions to identify one of the installations having the greatest amount of the match to one of the software licenses further comprises:
program instructions to identify the installation and the software license associated with a match amount having a greatest amount of match, wherein the installation environment of the associated installation satisfies the one or more license constraints of the associated software license.

16. The computer program product of claim 14, wherein the program instructions to determine the amount of match between the components of each of the respective installations, and the components licensed by each of the respective software licenses, further comprise:
program instructions to create a first vector, wherein each dimension of the first vector corresponds to a numerical count of each component of the respective sets of program components of the computer program for each of the plurality of installations;
program instructions to create a second vector, wherein each dimension of the second vector corresponds to a numerical count of each component of the respective sets of program components of the computer program for each of the plurality of software licenses;
program instructions to calculate a dot product of the first vector and the second vector;
program instructions to calculate a magnitude of the first vector and a magnitude of the second vector; and
program instructions to calculate a quotient of the dot product of the first vector and the second vector, and the product of the magnitude of the first vector and the magnitude of the second vector.

17. The computer program product of claim 16, wherein the program instructions to calculate a quotient further comprise:
program instructions to determine a count of components in the respective sets of program components of the computer program for each of the plurality of installations; and
program instructions to perform a normalizing operation on the quotient by multiplying the quotient by a logarithm of a summation of the count of components in the respective sets of program components of the computer program for each of the plurality of installations, and a value of one.

18. The computer program product of claim 14, further comprising:
program instructions to separately sort and store the amount of match between the components of each of the respective installations, and the components licensed by each of the respective software licenses, based on whether the software licenses licensing the respective sets of program components of the computer program are a serial model license or a hostname model license.

19. The computer program product of claim 14, wherein the program instructions to identify one of the installations having the greatest amount of the match to one the software licenses further comprises:
program instructions to identify the respective installations and the respective software licenses associated with the match amount wherein the match amount exceeds a predetermined amount of match.

20. The computer program product in accordance with claim 14, wherein the program instructions further includes:
one of the software licenses has at least the components to license the components of the one of the installations.
